(19) United States
(12) Patent Application Publication
(10) Pub. No.: US 2018/0154316 A1
(43) Pub. Date: Jun. 7, 2018

(54) WATER PURIFICATION

(71) Applicants: The University of Manchester, Manchester (GB); BGT Materials LTD, Manchester (GB)

(72) Inventors: Rahul Raveendran NAIR, Manchester (GB); Vasu Siddeswara KALANGI, Manchester (GB)

(73) Assignees: The University of Manchester, Manchester (GB); BGT Materials LTD, Manchester (GB)

(21) Appl. No.: 15/574,585

(22) PCT Filed: May 27, 2016
(86) PCT No.: PCT/GB16/51539

§ 371 Date: Nov. 16, 2017

(30) Foreign Application Priority Data
May 28, 2015 (GB) 1509157.2

(51) Int. Cl. B01D 67/00; B01D 69/10; B01D 69/12; B01D 71/02

(52) U.S. Cl. CPC B01D 67/0041; B01D 69/10; B01D 69/148; B01D 71/021; B01D 2323/30; B01D 69/12

(57) ABSTRACT

This invention relates to methods of purifying water using graphene oxide laminates which are formed from stacks of cross-linked individual graphene oxide flakes. The laminates also comprise graphene and/or at least one cross-linking agent. The invention also relates to the laminate membranes themselves.

This invention relates to methods of purifying water using graphene oxide laminates which are formed from stacks of cross-linked individual graphene oxide flakes which may be predominantly monolayer thick. The laminates also comprise graphene and/or at least one cross-linking agent. The invention also relates to the laminate membranes themselves.

### BACKGROUND

The removal of solutes from water finds application in many fields.

This may take the form of the purification of water for drinking or for watering crops or it may take the form of the purification of waste waters from industry to prevent environmental damage. Examples of applications for water purification include: the removal of salt from sea water for drinking water or for use in industry; the purification of brackish water; the removal of radioactive ions from water which has been involved in nuclear enrichment, nuclear power generation or nuclear clean-up (e.g. that involved in the decommissioning of former nuclear power stations or following nuclear incidents); the removal of environmentally hazardous substances (e.g. halogenated organic compounds, heavy metals, chlorates and perchlorates) from industrial waste waters before they enter the water system; and the removal of biological pathogens (e.g. viruses, bacteria, parasites, etc) from contaminated or suspect drinking water.

In many industrial contexts (e.g. the nuclear industry) it is often desirable to separate dangerous or otherwise undesired solutes from valuable (e.g. rare metals) solutes in industrial waste waters in order that the valuable solutes can be recovered and reused or sold.

Graphene is believed to be impermeable to all gases and liquids. Membranes made from graphene oxide are impermeable to most liquids, vapours and gases, including helium. However, an academic study has shown that, surprisingly, graphene oxide membranes having a thickness around 1 μm which are effectively composed of graphene oxide are permeable to water even though they are impermeable to helium. These graphene oxide sheets allow unimpeaded permeation of water (10¹⁰ times faster than He) (Nair et al. Science, 2012, 335, 442-444). Such GO laminates are particularly attractive as potential filtration or separation media because they are easy to fabricate, mechanically robust and offer no principal obstacles towards industrial scale production.

Sun et al (Selective Ion Penetration of Graphene Oxide Membranes; ACS Nano 7, 428 (2013)) describes the selective ion penetration of graphene oxide membranes in which the graphene oxide is formed by oxidation of wormlike graphite. The membranes are freestanding in the sense that they are not associated with a support material. The resultant graphene oxide contains more oxygen functional groups than graphene oxide prepared from natural graphite and laminates formed from this material have a wrinkled surface topography. Such membranes differ from those of the present invention because they do not show fast ion permeation of small ions and also demonstrate a selectivity which is substantially related to chemical and electrostatic interactions rather than size of ions.

This study found that sodium salts permeated quickly through GO membranes, whereas heavy metal salts permeated much more slowly. Copper sulphate and organic contaminants, such as rhodamine B are blocked entirely because of their strong interactions with GO membranes. According to this study, ionic or molecular permeation through GO is mainly controlled by the interaction between ions or molecules with the functional groups present in the GO sheets. The authors comment that the selectivity of the GO membranes cannot be explained solely by ionic-radius based theories. They measured the electrical conductivities of different permeate solutions and used this value to compare the permeation rates of different salts. The potential applied to measure the conductivities can affect ion permeation through membranes.

Other publications (Y. Han, Z. Xu, C. Gao. Adv. Fund. Mater. 23, 3693 (2013); M. Hu, B. Mi. Environ. Sci. Technol. 47, 3715 (2013); H. Huang et al. Chem. Comm. 49, 5963 (2013)) have reported filtration properties of GO laminates and, although results varied widely due to different fabrication and measurement procedures, they reported appealing characteristics including large water fluxes and notable rejection rates for certain salts. Unfortunately, large organic molecules were also found to pass through such GO filters. The latter observation is disappointing and would considerably limit interest in GO laminates as molecular sieves. In this respect, we note that the emphasis of these studies was on high water rates that could be comparable to or exceed the rates used for industrial desalination. Accordingly, a high water pressure was applied and the GO membranes were intentionally prepared as thin as possible, 10-50 nm thick. It may be that such thin stacks contained holes and cracks (some may appear after applying pressure), through which large organic molecules could penetrate.

Recently, Joshi et al have described the use of graphene oxide laminate membranes as size exclusion membranes (R. K. Joshi et al., 2014, Science, 343, 752-754). These membranes selectively excluded solutes having a hydration radius greater than about 4.5 Å. allowing solutes with a smaller radius to pass through. Unfortunately many solutes which might be desirable to be able to filter out, including for example NaCl, have hydration radii which are below 4.5 Å and thus cannot be excluded from passing through the membrane. The GO laminate membranes described in Joshi et al provide a water flux in the region of 2 L m⁻² h⁻¹, considerably lower than that typically obtained for commercial filtration membranes.

### BRIEF SUMMARY OF THE DISCLOSURE

In a first aspect of the invention is provided a method of reducing the amount of one or more solutes in an aqueous mixture to produce a liquid depleted in said solutes, the method comprising:
a) contacting a first face of a graphene oxide laminate membrane with the aqueous mixture comprising the one or more solutes;
b) recovering the liquid from or downstream from a second face of the graphene oxide laminate membrane;
   wherein the graphene oxide laminate membrane has a thickness greater than about 100 nm and wherein the graphene oxide flakes of which the membrane is comprised have an average oxygen:carbon weight ratio in the range of from 0.2:1.0 to 0.5:1.0 and wherein the membrane comprises GO flakes and at least one cross-linking agent. Thus, the membrane may comprise a cross-linking agent.

The cross-linked membranes used in the methods of the invention exhibit considerably higher fluxes compared to GO membranes which do not comprise cross-linking agents. Commercial desalination membranes typically provide water fluxes ranges from ˜1 L m⁻² h⁻¹ bar for seawater desalination to ˜7 L m⁻² h⁻¹ bar for high flux brackish water desalination. GO laminate membranes which do not comprise a cross-linking agent provide a water flux in the region of 2 L m⁻² h⁻¹ with 25 bar pressure. The water flux of the cross-linked GO laminate membranes used in the methods of the invention are between 6 and 10 L m⁻² h⁻¹ with 25 bar pressure, a significant improvement on the non-cross-linked membranes. It would not be expected that reducing the size of the pores in the hydrated membrane would lead to a higher flux. Furthermore, the presence of a foreign material such as a cross-linking agent in the GO membrane would be expected to impede the passage of fluid through the membrane as it would be expected to occupy some of the available voids of the material.

In a second aspect of the invention is provided a method of reducing the amount of one or more solutes in an aqueous mixture to produce a liquid depleted in said solutes, the method comprising:
a) contacting a first face of a graphene oxide laminate membrane with the aqueous mixture comprising the one or more solutes;
b) recovering the liquid from or downstream from a second face of the graphene oxide laminate membrane;
   wherein the graphene oxide laminate membrane comprises GO flakes and graphene flakes. The membrane may also comprise at least one cross-linking agent. The graphene flakes may be monolayer flakes and/or few layer flakes.

It may be that the graphene oxide laminate membrane has a thickness greater than about 100 nm and that the graphene oxide flakes of which the membrane is comprised have an average oxygen:carbon weight ratio in the range of from 0.2:1.0 to 0.5:1.0.

The inventors have found that graphene/GO composite membranes can be used as filtration membranes. Given that graphene itself is impermeable it is perhaps surprising that such composites can form an effective membrane.

The inventors have also found that by including cross-linking agents or graphene in GO laminate membranes, the expansion of the pores which usually occurs on hydration of GO laminate membranes is reduced. This in turn can allow the membrane to exclude smaller ions than would be excluded with GO laminate membranes which do not comprise a cross-linking agent or graphene, i.e. ions with hydration radii below 4.5 Å. Additionally, or alternatively, it can allow the membrane to be more effective at excluding those smaller ions that can pass through. The extent to which any given cross-linking agent constrains the membrane (i.e. limits the expansion of the pores) on hydration of the membrane varies depending on the identity of the cross-linking agent.

As the hydration radius at which an ion cannot pass through the membrane is directly related to the d-spacing of the hydrated laminate membrane, the size exclusion selectivity of these classes of membranes can be tuned by selecting an appropriate cross-linking agent and/or graphene. Thus, a membrane, and particularly the cross-linking agent and/or graphene of which the membrane is comprised, may be selected dependent on the size of the ions which are being filtered.

The cross-linked membranes used in the methods of the invention exhibit improved rejection of salts (e.g. NaCl) relative to GO membranes which do not comprise a cross-linking agent.

Likewise, the graphene-GO (Gr-GO) composite membranes used in the methods of the invention exhibit improved rejection of salts (e.g. NaCl) relative to GO membranes which do not comprise graphene. Gr-GO membranes do not exhibit a significant reduction in water flux relative to GO membranes which do not comprise graphene.

Indeed, for certain applications, the graphene GO composite membranes are more effective at rejecting salts than cross-linked GO membranes. Despite the fact that graphene is less effective relative to many cross-linking agents at constraining the expansion of membranes on hydration, the two dimensional structure and more homogeneous distribution of graphene flakes through the membrane than the cross-linking agents give rise to higher salt rejection. It is believed that the areas of inhomogeneity in the cross-linked GO membranes give rise to lower salt rejection than expected based solely on the constraint the cross-linker applies to the pores of the membrane.

It may be that the graphene flakes represent from 0.5 wt % to 10 wt % of the flakes of which the graphene oxide laminate membrane is comprised. It may be that the graphene flakes represent from 1 wt % to 7.5 wt % of the flakes of which the graphene oxide laminate membrane is comprised. It may be that the graphene flakes represent from 2 wt % to 6 wt % of the flakes of which the graphene oxide laminate membrane is comprised. The inventors have found that the salt rejection properties of a GO composite are improved by the inclusion of as little as about 1 wt % graphene. They have also found that when about 5 wt % graphene is included, the permeation rates of salts drop by around three orders of magnitude.

Without wishing to be bound by theory, it is believed that the inclusion of too much graphene in the GO laminate membranes can make them too brittle for practical use and can also lead to a loss of capillaries within the membranes meaning that water flux can be lower for larger amounts of graphene.

It may be that greater than 50% by weight (e.g. greater than 75% by weight, greater than 90% or greater than 98%) of the graphene flakes have a diameter of less than 10 μm. It may be that greater than 50% by weight (e.g. greater than 75% by weight, greater than 90% or greater than 98%) of the graphene flakes have a diameter of greater than 50 nm. It may be that greater than 50% by weight (e.g. greater than 75% by weight, greater than 90% or greater than 98%) of the graphene flakes have a diameter of less than 5 μm. It may be that greater than 50% by weight (e.g. greater than 75% by weight, greater than 90% or greater than 98%) of the graphene flakes have a diameter of greater than 100 nm. It may be that greater than 50% by weight (e.g. greater than 75% by weight, greater than 90% or greater than 98%) of the graphene flakes have a diameter of less than 1 μm. It may be that greater than 50% by weight (e.g. greater than 75% by weight, greater than 90% or greater than 98%) of the graphene flakes have a diameter of less than 500 nm.

It may be that greater than 50% by weight (e.g. greater than 75% by weight, greater than 90% or greater than 98%) of the graphene has a thickness of from 1 to 10 atomic layers. It may be that greater than 50% by weight (e.g. greater than 75% by weight, greater than 90% or greater than 98%) of the graphene has a thickness of from 1 to 5 molecular layers. Thus, it may be that greater than 50% by weight (e.g. greater than 75% by weight, greater than 90% or greater than 98%) of the graphene has a thickness of from 1 to 3 molecular layers. It may be that greater than 50% by weight (e.g. greater than 75% by weight, greater than 90% or greater than 98%) of the graphene is single layer graphene.

It may be that greater than 50% by weight (e.g. greater than 75% by weight, greater than 90% or greater than 98%) of the graphene oxide flakes have a diameter of less than 10 μm. It may be that greater than 50% by weight (e.g. greater than 75% by weight, greater than 90% or greater than 98%) of the graphene oxide flakes have a diameter of greater than 50 nm. It may be that greater than 50% by weight (e.g. greater than 75% by weight, greater than 90% or greater than 98%) of the graphene oxide flakes have a diameter of less than 5 μm. It may be that greater than 50% by weight (e.g. greater than 75% by weight, greater than 90% or greater than 98%) of the graphene oxide flakes have a diameter of greater than 100 nm. It may be that greater than 50% by weight (e.g. greater than 75% by weight, greater than 90% or greater than 98%) of the graphene oxide flakes have a diameter of less than 2 μm. It may be that greater than 50% by weight (e.g. greater than 75% by weight, greater than 90% or greater than 98%) of the graphene oxide flakes have a diameter of less than 1 μm. It may be that greater than 50% by weight (e.g. greater than 75% by weight, greater than 90% or greater than 98%) of the graphene oxide flakes have a diameter of less than 500 nm. It may be that greater than 50% by weight (e.g. greater than 75% by weight, greater than 90% or greater than 98%) of the graphene oxide flakes have a diameter of greater than 500 nm.

It may be that greater than 50% by weight (e.g. greater than 75% by weight, greater than 90% or greater than 98%) of the graphene oxide has a thickness of from 1 to 10 atomic layers. It may be that greater than 50% by weight (e.g. greater than 75% by weight, greater than 90% or greater than 98%) of the graphene oxide has a thickness of from 1 to 5 molecular layers. Thus, it may be that greater than 50% by weight (e.g. greater than 75% by weight, greater than 90% or greater than 98%) of the graphene oxide has a thickness of from 1 to 3 molecular layers. It may be that greater than 50% by weight (e.g. greater than 75% by weight, greater than 90% or greater than 98%) of the graphene oxide is single layer graphene oxide.

The solutes which are depleted in the liquid have a hydration radius below a specific size exclusion limit. It may be that the size exclusion limit is in the range of from about 3.0 Å to about 4.5 Å. It may be that the size exclusion limit is in the range of from about 3.25 Å to about 4.25 Å. It may be that the size exclusion limit is in the range of from about 3.5 Å to about 4.0 Å.

The size exclusion limit depends in part on the average spacing between the GO flakes, i.e. the height of the capillaries. This average spacing can be measured indirectly, using x-ray diffraction, as the d-spacing, which can be calculated from the x-ray diffraction peaks using Bragg's law. The d-spacing of a laminate membrane is effectively the sum of the thickness of the GO flake and the distance between the GO flakes. The observed d-spacing will be an average, the standard deviation of which will depend on the width of the x-ray diffraction peaks. The width of the x-ray diffraction peaks indicates how much variation there is in the thickness of the GO flake and the distance between the GO flakes. The x-ray diffraction peaks in cross-linked GO laminate membranes tend to be broader than those in non-cross-linked membranes, indicating that there is a greater variation in the capillary size.

It may be that, when hydrated, the graphene oxide laminate membrane has a d-spacing below 12 Å. The d-spacing of the hydrated graphene oxide laminate membrane may be below 11 Å. The d-spacing of the hydrated graphene oxide laminate membrane may be below 10 Å. The d-spacing of the hydrated graphene oxide laminate membrane may be below 9 Å. The d-spacing of the hydrated graphene oxide laminate membrane may be below 8 Å. The d-spacing of the hydrated graphene oxide laminate membrane may be below 7 Å.

The inventors have observed empirically a relationship between the size exclusion limit and the d-spacing of the hydrated membrane. The capillary size of the hydrated membrane is the d-spacing minus the thickness of the GO flakes (typically between 3 and 3.5 Å). The size exclusion limit is typically about half the capillary size. Thus hydrated GO membranes with a d-spacing of between 12 and 13 have a capillary size of between about 9 and 9.5 and a size exclusion cut off of about 4.5. Likewise, a hydrated GO-polyAMPS cross-linked membrane has a d-spacing of about 9.1 Å, which would be expected to provide a capillary size of between about 5.5 and 6 Å and a size exclusion of about 3. It has been observed that the GO-polyAMPS cross-linked membrane exhibits excellent rejection of NaCl (the hydration radius of Na is 3.58 Å).

In certain embodiments, the method is a process of selectively reducing the amount of a first set of one or more solutes in an aqueous mixture without significantly reducing the amount of a second set of one or more solutes in the aqueous mixture to produce a liquid depleted in said first set of solutes but not depleted in said second set of solutes. In these embodiments, the or each solute of the first set has a radius of hydration greater than the size exclusion limit and the or each solute of the second set has a radius of hydration less than the size exclusion limit.

It may be that the method is continuous. Thus, steps a) and b) may be carried out simultaneously or substantially simultaneously. Steps a) and b) may also be carried out iteratively in a continuous process to enhance enrichment or iteratively in a batch process.

It may be that the aqueous mixture is permitted to pass through the membrane by diffusion and/or it may be that a pressure is applied. Preferably, pressure is applied.

Preferably, no electrical potential is applied across the membrane. In principle, an electrical potential could be applied to modify the transport of ions through the membrane.

The graphene oxide laminate membrane is optionally supported on a porous material. This can provide structural integrity. In other words, the graphene oxide flakes may themselves form a layer e.g. a laminate which itself is associated with a porous support such as a porous membrane to form a further laminate structure. In this embodiment, the resulting structure is a laminate of graphene flakes mounted on the porous support. In one illustrative example, the graphene oxide laminate membrane may be sandwiched between layers of a porous material. The use of a porous support is particularly preferred where the graphene oxide laminate membrane also comprises graphene. Such membranes can be brittle.

It may be that the graphene oxide flakes of which the laminate is comprised have an average oxygen:carbon weight ratio in the range of from 0.2:1.0 to 0.5:1.0, e.g. from 0.25:1.0 to 0.45:1.0. Preferably, the flakes have an average oxygen:carbon weight ratio in the range of from 0.3:1.0 to 0.4:1.0.

The GO flakes which form the membranes may have been prepared by the oxidation of natural graphite.

The term “solute” applies to both ions and counter-ions, and to uncharged molecular species present in the solution. Once dissolved in aqueous media a salt forms a solute comprising hydrated ions and counter-ions. The uncharged molecular species can be referred to as “non-ionic species”. Examples of non-ionic species are small organic molecules such as aliphatic or aromatic hydrocarbons (e.g. toluene, benzene, hexane, etc), alcohols (e.g. methanol, ethanol, propanol, glycerol, etc), carbohydrates (e.g. sugars such as sucrose), and amino acids and peptides. The non-ionic species may or may not bind with water through hydrogen bonds. As will be readily apparent to the person skilled in the art, the term ‘solute’ does not encompass solid substances which are not dissolved in the aqueous mixture. Particulate matter will not pass through the membranes of the invention even if the particulate is comprised of ions with small radii.

The term “hydration radius” refers to the effective radius of the molecule when solvated in aqueous media.

The reduction of the amount one or more selected solutes in the solution which is treated with the GO membrane of the present invention may entail entire removal of the or each selected solute. Alternatively, the reduction may not entail complete removal of a particular solute but simply a lowering of its concentration. The reduction may result in an altered ratio of the concentration of one or more solutes relative to the concentration of one or more other solutes. In cases in which salt is formed from one ion having a hydration radius of larger than the size exclusion limit and a counter-ion with a hydration radius below the size exclusion limit, neither ion will pass through the membrane of the invention because of the electrostatic attraction between the ions. Thus, for example, if an NaCl solution were passed through a membrane having a size exclusion limit of 3.5 Å, the amount of both the Na+ ions (hydration radius: 3.58 Å) and the Cl− ions (hydration radius: 3.32 Å) would be reduced, even though the Cl⁻ ions have a hydration radius below the size exclusion limit.

The precise value of the size exclusion limit for any given laminate membrane may vary depending on application. In the region around the size exclusion limit, the degree of transmission decreases by orders of magnitude and consequently the effective value of the size exclusion limit depends on the amount of transmission of solute that is acceptable for a particular application.

The flakes of graphene oxide which are stacked to form the laminate of the invention are usually monolayer graphene oxide. However, it is possible to use flakes of graphene oxide containing from 2 to 10 atomic layers of carbon in each flake. These multilayer flakes are frequently referred to as “few-layer” flakes. Thus the membrane may be made entirely from monolayer graphene oxide flakes, from a mixture of monolayer and few-layer flakes, or from entirely few-layer flakes. Ideally, the flakes are entirely or predominantly, i.e. more than 75% w/w, monolayer graphene oxide.

The graphene oxide laminates used in the methods of the invention have the overall shape of a sheet-like material through which solutes having a size below a certain size exclusion limit may pass when the laminate is wet with an aqueous or aqueous-based mixture optionally containing one or more additional solvents (which may be miscible or immiscible with water). The solute may only pass provided it is of sufficiently small size. Thus the aqueous solution contacts one face or side of the membrane and purified solution is recovered from the other face or side of the membrane.

The method may involve a plurality of cross-linked graphene oxide laminate membranes. These may be arranged in parallel (to increase the flux capacity of the process/device) or in series (where a reduction in the amount of one or more solute is achieved by a single laminate membrane but that reduction is less than desired).

The graphene oxide laminate membrane may have a thickness greater than about 100 nm, e.g. greater than about 500 nm, e.g. a thickness between about 500 nm and about 100 μm. The graphene oxide laminate membrane may have a thickness up to about 50 μm. The graphene oxide laminate membrane may have a thickness greater than about 1 μm, e.g. a thickness between 1 μm and 15 μm. Thus, the graphene oxide laminate membrane may have a thickness of about 5 μm.

A cross linking agent is a substance which bonds with GO flakes in the laminate. The cross linking agent may form hydrogen bonds with GO flakes or it may form covalent bonds with GO flakes. Examples (which are included in some embodiments of the invention but which may be specifically excluded from other embodiments of the invention) include diamines (e.g. ethyl diamine, propyl diamine, phenylene diamine), polyallylamines and imidazole. Without wishing to be bound by theory, it is believed that these are examples of crosslinking agents which form hydrogen bonds with GO flakes. Other examples include borate ions and polyetherimides formed from capping the GO with polydopamine. Examples of appropriate cross linking systems can be found in Tian et al, (Adv. Mater. 2013, 25, 2980-2983), An et al (Adv. Mater. 2011, 23, 3842-3846), Hung et al (Cross-linking with Diamine monomers to Prepare Composite Graphene Oxide-Framework Membranes with Varying d-Spacing; Chemistry of Materials, 2014) and Park et al (Graphene Oxide Sheets Chemically Cross-Linked by polyallylamine; J. Phys. Chem. C; 2009).

The crosslinking agent may be a polymer. The polymer may be interspersed throughout the membrane. It may occupy the spaces between graphene oxide flakes, thus providing interlayer crosslinking. Examples (which are included in some embodiments of the invention but which may be specifically excluded from other embodiments of the invention) include PVA (see for example Li et al Adv. Mater. 2012, 24, 3426-3431), poly(4-styrenesulfonate), Nafion, carboxymethyl cellulose, Chitosan, polyvinyl pyrrolidone, polyaniline etc. A preferred polymer is poly(2-acrylamido-2-methyl-1-propanesulfonic acid. It may be that the polymer is water soluble. Alternatively, it may be that the polymer is not water soluble.

The cross-linking agent may be a charged polymer, e.g. one which comprises sulfonic acids or other ionisable functional groups. Exemplary charged polymers include poly(4-styrenesulfonate), Nafion and poly(2-acrylamido-2-methyl-1-propanesulfonic acid.

The cross-linking agent (e.g. polymer or charged polymer) may be present in an amount from about 0.1 to about 50 wt %, e.g. from about 5 to about 45 wt %. Thus, the GO laminate may comprise from about 2 to about 25 wt % cross-linking agent (e.g. polymer or charged polymer). the GO laminate may comprise up to about 20 wt % cross-linking agent (e.g. polymer or charged polymer).

The graphene flakes may be monolayer graphene flakes. They may be few-layer (i.e. 2-10 atomic layers, e.g. 3-7 atomic layers) graphene flakes. The graphene may be a reduced graphene oxide or partially oxidized graphene. Preferably, however, it is pristine graphene. The graphene may be pristine graphene with small holes in it. The defects in reduced graphene oxide or partially oxidized graphene or holes in pristine graphene can lead to higher fluxes.

The GO laminates may comprise other inorganic materials, e.g. other two dimensional materials, such as hBN, mica. The presence of mica, for example can slightly improve the mechanical properties of the GO laminate.

It may be that, if present, the porous support is an inorganic material. Thus, the porous support (e.g. membrane) may comprise a ceramic. Preferably, the support is alumina, zeolite, or silica. In one embodiment, the support is alumina. Zeolite A can also be used. Ceramic membranes have also been produced in which the active layer is amorphous titania or silica produced by a sol-gel process.

It may be that, if present, the porous support is a polymeric material. Thus, the porous support may thus be a porous polymer support, e.g. a flexible porous polymer support. Preferably it is PES, PTFE, PVDF or Cyclopore™ polycarbonate. In an embodiment, the porous support (e.g. membrane) may comprise a polymer. In an embodiment, the polymer may comprise a synthetic polymer. These can be used in the invention. Alternatively, the polymer may comprise a natural polymer or modified natural polymer. Thus, the polymer may comprise a polymer based on cellulose. The polymer support may be derived from a charged polymer such as one which contains sulfonic acids or other ionisable functional groups.

It may be that, if present, the porous support (e.g. membrane) may comprise a carbon monolith.

In an embodiment, the porous support layer has a thickness of no more than a few tens of μm, and ideally is less than about 100 μm. Preferably, it has a thickness of 50 μm or less, more preferably of 10 μm or less, and yet more preferably is less 5 μm. In some cases it may be less than about 1 μm thick though preferably it is more than about 1 μm.

Preferably, the thickness of the entire membrane (i.e. the graphene oxide laminate and the support, if present) is from about 1 μm to about 200 μm, e.g. from about 5 μm to about 50.

The porous support should be porous enough not to interfere with water transport but have small enough pores that graphene oxide platelets cannot enter the pores. Thus, the porous support must be water permeable. In an embodiment, the pore size must be less than 1 μm. In an embodiment, the support has a uniform pore-structure. Examples of porous membranes with a uniform pore structure are electrochemically manufactured alumina membranes (e.g. those with the trade names: Anopore™, Anodisc™).

The one or more solutes can be ions and/or they could be neutral organic species, e.g. sugars, hydrocarbons etc. Where the solutes are ions they may be cations and/or they may be anions.

In certain preferred embodiments, the solutes are Na⁺ ions and/or Cl⁻ ions. Thus the method may be a method of desalination (i.e. a method of reducing the amount of NaCl in an aqueous mixture).

In a third aspect of the invention is provided a method of reducing the amount of one or more predetermined solutes having a hydration radius in the range of from about 3.5 Å to about 4.5 Å in an aqueous mixture to produce a liquid depleted in the predetermined solutes, the method comprising;
a) determining the identity of one or more solutes in the aqueous mixture which are to be selected for exclusion by the membrane;
b) correlating the required d-spacing in the graphene oxide membrane with the hydration radius of the or each predetermined solute;
c) forming a graphene oxide laminate membrane comprising GO flakes and also comprising monolayer or few layer graphene flakes and/or at least one cross linking agent and having a reduced d-spacing relative to a membrane which does not comprise the cross-linking agent;
d) contacting a first face of a graphene oxide laminate membrane with the aqueous mixture comprising one or more solutes; and
e) recovering the liquid from or downstream from a second face of the membrane.

It may be that steps d) and e) are performed continuously. Thus, steps d) and e) may be carried out simultaneously or substantially simultaneously.

In a fourth aspect of the invention is provided a method of tuning the d-spacing of a cross-linked graphene oxide laminate size exclusion filtration membrane, the method comprising:
a) selecting at least one cross-linking agent and/or monolayer or few layer graphene flakes which provides a membrane having a desired capillary size when the membrane is hydrated; and
b) forming a graphene oxide laminate membrane comprising GO flakes and also comprising monolayer or few layer graphene flakes and/or the at least one cross linking agent.

In a fifth aspect of the invention is provided a method of limiting the d-spacing of a hydrated graphene oxide laminate size exclusion filtration membrane to below 12 Å, the method comprising:
forming a graphene oxide laminate membrane comprising GO flakes and also comprising monolayer or few layer graphene flakes and/or at least one cross linking agent.

The cross-linking agent is solubilised by reference to cross-linking agents that have been determined experimentally to provide the required d-spacing or less.

In a sixth aspect of the invention is provided the use of monolayer or few layer graphene flakes and/or at least one cross linking agent to limit the d-spacing of a hydrated graphene oxide laminate size exclusion filtration membrane to below 12 Å.

Suitable cross-linking agents and the means for determining them are described herein.

In a seventh aspect of the invention is provided a graphene oxide laminate membrane comprising GO flakes and a charged polymer (e.g. poly(2-acrylamido-2-methyl-1-propanesulfonic acid) as a cross-linking agent. The charged polymer may be one which comprises sulfonic acids or other ionisable functional groups. Exemplary charged polymers include poly(4-styrenesulfonate), Nafion and poly(2-acrylamido-2-methyl-1-propanesulfonic acid.

In an eighth aspect of the invention is provided a graphene oxide laminate membrane comprising GO flakes and at least one cross linking agent and having, when hydrated, a reduced pore size relative to a hydrated graphene oxide membrane which does not comprise the cross-linking agent, and wherein the pore size in the hydrated membrane is operative to substantially exclude at least the passage of solutes having a hydration radius in the range of from about 3.5 Å to about 4.5 Å when present in an aqueous mixture.

In a ninth aspect of the invention is provided a graphene oxide laminate membrane comprising GO flakes and monolayer or few layer graphene flakes.

In a tenth aspect of the invention is provided a method of producing a graphene oxide laminate membrane comprising GO flakes and graphene flakes, the method comprising:
a) providing a suspension of graphite flakes and graphite oxide flakes in an aqueous medium;
b) subjecting the graphite flakes and graphite oxide flakes in the aqueous medium to energy to obtain an aqueous suspension comprising graphene flakes and graphene oxide flakes;
c) optionally removing any graphite, graphite oxide or undesired few-layered graphene/graphene oxide flakes from the suspension; and
d) filtering the suspension through a porous material to provide a graphene oxide laminate membrane comprising GO flakes and graphene flakes, the laminate membrane being supported on the porous material.

The energy applied in step (b) may be sonic energy. The sonic energy may be ultrasonic energy. It may be delivered in using a bath sonicator or a tip sonicator. Alternatively the energy may be a mechanical energy, e.g. shear force energy or grinding. The particles may be subjected to energy (e.g. sonic energy) for a length of time from 15 min to 1 week, depending on the properties and proportions (flake diameter and thickness) desired. The particles may be subjected to energy (e.g. sonic energy) for a length of time from 1 to 4 days.

Where the desired laminate membrane also comprises cross-linking agents, these will be present in the aqueous medium prior to filtration. They may be present in the suspension of graphite and graphite oxide or they may be added after step b) or, if present, step c).

The term ‘aqueous medium’ can be understood to mean a liquid which contains water, e.g. which contains greater than 20% by volume water. The aqueous medium may contain more than 50% by volume water, e.g. more than 75% by volume water or more than 95% by volume water. The aqueous medium may also comprise solutes or suspended particles and other solvents (which may or may not be miscible with water). The aqueous medium may comprise additives which may be ionic, organic or amphiphilic. Examples of such additives include surfactants, viscosity modifiers, pH modifiers, iconicity modifiers, and dispersants. It may be however that the aqueous medium consists essentially of water, graphite and graphite oxide and optionally one or more cross-linking agents

The step of reducing the amount of multilayered particles in the suspension may comprise using a centrifuge.

Graphene oxide is able to stabilise graphene flakes in an aqueous medium, similarly to the action of various surfactants. Thus, once the graphite oxide has been exfoliated, the thus formed graphene oxide flakes encourage the exfoliation of the graphite into graphene flakes and/or stabilise the graphene flakes once they have been exfoliated. Smaller GO flakes are more effective dispersants than larger GO flakes (e.g. less than 1 μm or less than 500 nm).

Typically, the exfoliation of graphite oxide is more efficient than the exfoliation of graphite. Thus, the starting suspension might contain more graphite than graphite oxide. Indeed, the ratio of graphite to graphite oxide may be larger than that desired in the product membrane. For example, the inventors have found that a weight ratio of 9:1 graphite:graphite oxide mixture gives rise to a membrane which is 5.5 wt % graphene.

In an eleventh aspect of the invention is provided a filtration device comprising a membrane of the seventh, eighth or ninth aspects of the invention. The filtration device may be a filter assembly or it may be a removable and replaceable filter for use in a filter assembly.

In certain embodiments, it may be that the cross-linking agent is not selected from: diamine; pollyallylamine; imidazole; borate ions; polyetherimides formed from capping GO with polypodamine; PVA; poly(4-styrenesulfonate); Nafion, caboxymethyl cellulose; chitosan; polyvinyl pyrrolidone; and polyaniline. This applies in particular to the third to eighth aspects of the invention.

In any of the third to tenth aspects of the invention, it may be that the graphene oxide laminate membrane has a thickness greater than about 100 nm. Likewise, it may be that the graphene oxide flakes of which the laminate is comprised have an average oxygen:carbon weight ratio in the range of from 0.2:1.0 to 0.5:1.0.

Where not mutually exclusive, any of the embodiments described above in relation to the first and/or second aspects of the invention apply equally to one or more of the second to eleventh aspects of the invention.

### BRIEF DESCRIPTION OF THE DRAWINGS

Embodiments of the invention are further described hereinafter with reference to the accompanying drawings, in which:

FIG. 1 shows the x-ray diffraction peaks for selected cross-linked and non-cross-linked laminate membranes before hydration and the corresponding observed d-spacings.

FIG. 2 shows the d-spacing of selected cross-linked and non-cross-linked laminate membranes both before (Bf Hyd) and after (Af Hyd) hydration.

FIG. 3 shows the water flux of selected cross-linked and non-cross-linked laminate membranes (with an applied pressure of 25 bar).

FIG. 4 shows the NaCl rejection of selected cross-linked and non-cross-linked laminate membranes as an average across all measurements.

FIG. 5 shows the NaCl rejection of selected cross-linked and non-cross-linked laminate membranes in terms of the value obtained for each measurement.

FIG. 6 shows the MgCl₂ rejection of selected cross-linked and non-cross-linked laminate membranes.

FIG. 7 shows (a) Cross sectional and (b) in-plane scanning electron micrograph of Gr-GO membrane. Flaky features in the in-plane SEM image are from the exfoliated graphene in the membrane (c) represents the schematic of the structure of Gr-GO membrane (longer lines—GO and shorter lines—graphene).

FIG. 8 shows Gr-GO Suspensions. (a) Photograph of GO and Gr-GO aqueous colloidal suspensions (concentration ˜100 μg/ml) with increasing wt % of graphene from left to right. (b) The concentration and estimated wt % of exfoliated graphene in Gr-GO membrane as a function of initial graphite oxide/graphite weight ratio. (c) Shift in two-theta position of the (001) diffraction peak of GO and Gr-GO membranes in dry and wet states. (d) Permeation rate of K⁺, Na⁺, Li⁺ and Mg⁺² ions through pristine GO, Gr-GO membranes made of 1:2 and 1:9 dispersions. The shown permeation rates are measured using 5 μm thick membranes.

### DETAILED DESCRIPTION

The present invention involves the use of graphene oxide laminate membranes. The graphene oxide laminates and laminate membranes of the invention comprise stacks of individual graphene oxide flakes, in which the flakes are predominantly monolayer graphene oxide. Although the flakes are predominantly monolayer graphene oxide, it is within the scope of this invention that some of the graphene oxide is present as two- or few-layer graphene oxide. Thus, it may be that at least 75% by weight of the graphene oxide is in the form of monolayer graphene oxide flakes, or it may be that at least 85% by weight of the graphene oxide is in the form of monolayer graphene oxide flakes (e.g. at least 95%, for example at least 99% by weight of the graphene oxide is in the form of monolayer graphene oxide flakes) with the remainder made up of two- or few-layer graphene oxide. Without wishing to be bound by theory, it is believed that water and solutes pass through capillary-like pathways formed between the graphene oxide flakes by diffusion and that the specific structure of the graphene oxide laminate membranes leads to the remarkable selectivity observed as well as the remarkable speed at which the ions permeate through the laminate structure.

Graphene oxide flakes are two dimensional heterogeneous macromolecules containing both hydrophobic ‘graphene’ regions and hydrophilic regions with large amounts of oxygen functionality (e.g. epoxide, carboxylate groups, carbonyl groups, hydroxyl groups)

In one illustrative example, the graphene oxide laminate membranes are made of impermeable functionalized graphene sheets that have a typical size L≈μm and the interlayer separation, d, sufficient to accommodate a mobile layer of water.

The solutes to be removed from aqueous mixtures in the methods of the present invention may be defined in terms of their hydrated radius. Below are the hydrated radii of some exemplary ions and molecules.

TABLE 1

| | Hydrated | | Hydrated |
|---|---|---|---|
| Ion/molecule | radius (Å) | Ion/molecule | radius (Å) |
| K⁺ | 3.31 | Li⁺ | 3.82 |
| Cl⁻ | 3.32 | Rb⁺ | 3.29 |
| Na⁺ | 3.58 | Cs⁺ | 3.29 |
| CH₃COO⁻ | 3.75 | NH₄⁺ | 3.31 |
| SO₄²⁻ | 3.79 | Be²⁺ | 4.59 |
| AsO₄³⁻ | 3.85 | Ca²⁺ | 4.12 |
| CO₃²⁻ | 3.94 | Zn²⁺ | 4.30 |
| Cu²⁺ | 4.19 | Ag⁺ | 3.41 |
| Mg²⁺ | 4.28 | Cd²⁺ | 4.26 |
| propanol | 4.48 | Al³⁺ | 4.80 |
| glycerol | 4.65 | Pb²⁺ | 4.01 |
| [Fe(CN)₆]³⁻ | 4.75 | NO₃⁻ | 3.40 |
| sucrose | 5.01 | OH⁻ | 3.00 |
| (PTS)⁴⁻ | 5.04 | H₃O⁺ | 2.80 |
| [Ru(bipy)₃]²⁺ | 5.90 | Br⁻ | 3.30 |
| Tl⁺ | 3.30 | I⁻ | 3.31 |

The hydrated radii of many species are available in the literature. However, for some species the hydrated radii may not be available. The radii of many species are described in terms of their Stokes radius and typically this information will be available where the hydrated radius is not. For example, of the above species, there exist no literature values for the hydrated radius of propanol, sucrose, glycerol and PTS⁴⁻. The hydrated radii of these species which are provided in the table above have been estimated using their Stokes/crystal radii. To this end, the hydrated radii for a selection of species in which this value was known can be plotted as a function of the Stokes radii for those species and this yields a simple linear dependence. Hydrated radii for propanol, sucrose, glycerol and PTS⁴⁻ were then estimated using the linear dependence and the known Stokes radii of those species.

There are a number of methods described in the literature for the calculation of hydration radii. Examples are provided in ‘Determination of the effective hydrodynamic radii of small molecules by viscometry’; Schultz and Soloman; The Journal of General Physiology; 44; 1189-1199 (1963); and ‘Phenomenological Theory of Ion Solvation’; E. R. Nightingale. J. Phys. Chem. 63, 1381 (1959).

The term ‘aqueous mixture’ refers to any mixture of substances which comprises at least 10% water by weight. It may comprise at least 50% water by weight and preferably comprises at least 80% water by weight, e.g. at least 90% water by weight. The mixture may be a solution, a suspension, an emulsion or a mixture thereof. Typically the aqueous mixture will be an aqueous solution in which one or more solutes are dissolved in water. This does not exclude the possibility that there might be particulate matter, droplets or micelles suspended in the solution. Of course, it is expected that the particulate matter will not pass through the membranes of the invention even if it is comprised of ions with small radii.

Particularly preferred solutes for removing from water include hydrocarbons and oils, biological material, dyes, organic compounds (including halogenated organic compounds), complex ions, NaCl, heavy metals, ethanol, chlorates and perchlorates and radioactive elements.

The graphene oxide or graphite oxide for use in this application can be made by any means known in the art. In a preferred method, graphite oxide can be prepared from graphite flakes (e.g. natural graphite flakes) by treating them with potassium permanganate and sodium nitrate in concentrated sulphuric acid. This method is called Hummers method. Another method is the Brodie method, which involves adding potassium chlorate (KClO₃) to a slurry of graphite in fuming nitric acid. For a review see, Dreyer et al. The chemistry of graphene oxide, Chem. Soc. Rev., 2010, 39, 228-240.

Individual graphene oxide (GO) sheets can then be exfoliated by dissolving graphite oxide in water or other polar solvents with the help of ultrasound, and bulk residues can then be removed by centrifugation and optionally a dialysis step to remove additional salts.

In a specific embodiment, the graphene oxide of which the graphene oxide laminate membranes of the invention are comprised is not formed from wormlike graphite. Worm-like graphite is graphite that has been treated with concentrated sulphuric acid and hydrogen peroxide at 1000° C. to convert graphite into an expanded “worm-like” graphite. When this worm-like graphite undergoes an oxidation reaction it exhibits a higher increase the oxidation rate and efficiency (due to a higher surface area available in expanded graphite as compared to pristine graphite) and the resultant graphene oxide contains more oxygen functional groups than graphene oxide prepared from natural graphite. Laminate membranes formed from such highly functionalized graphene oxide can be shown to have a wrinkled surface topography and lamellar structure (Sun et al; Selective Ion Penetration of Graphene Oxide Membranes; ACS Nano 7, 428 (2013) which differs from the layered structure observed in laminate membranes formed from graphene oxide prepared from natural graphite. Such membranes do not show fast ion permeation of small ions and a selectivity which is substantially unrelated to size (being due rather to interactions between solutes and the graphene oxide functional groups) compared to laminate membranes formed from graphene oxide prepared from natural graphite.

The preparation of graphene oxide laminate supported on a porous membrane can be achieved using filtration, spray coating, casting, dip coating techniques, road coating, inject printing, or any other thin film coating techniques

For large scale production of supported graphene based membranes or sheets it is preferred to use spray coating, road coating or inject printing techniques. One benefit of spray coating is that spraying GO solution in water on to the porous support material at an elevated temperature produces a large uniform GO film.

Graphite oxide consists of micrometer thick stacked graphite oxide flakes (defined by the starting graphite flakes used for oxidation, after oxidation it gets expanded due to the attached functional groups) and can be considered as a polycrystalline material. Exfoliation of graphite oxide in water into individual graphene oxide flakes was achieved by the sonication technique followed by centrifugation at 10000 rpm to remove few layers and thick flakes. Graphene oxide laminates were formed by restacking of these single or few layer graphene oxides by a number of different techniques such as spin coating, spray coating, road coating and vacuum filtration.

Graphene oxide membranes according to the invention consist of overlapped layers of randomly oriented single layer graphene oxide sheets with smaller dimensions (due to sonication). These membranes can be considered as centimetre size single crystals (grains) formed by parallel graphene oxide sheets. Due to this difference in layered structure, the atomic structure of the capillary structure of graphene oxide membranes and graphite oxide are different. For graphene oxide membranes the edge functional groups are located over the non-functionalised regions of another graphene oxide sheet while in graphite oxide mostly edges are aligned over another graphite oxide edge. These differences unexpectedly may influence the permeability properties of graphene oxide membranes as compared to those of graphite oxide.

A layer of graphene consists of a sheet of sp²-hybridized carbon atoms. Each carbon atom is covalently bonded to three neighboring carbon atoms to form a ‘honeycomb’ network of tessellated hexagons. Carbon nanostructures which have more than 10 graphene layers (i.e. 10 atomic layers; 3.5 nm interlayer distance) generally exhibit properties more similar to graphite than to mono-layer graphene. Thus, throughout this specification, the term graphene is intended to mean a carbon nanostructure with up to 10 graphene layers. A graphene layer can be considered to be a single sheet of graphite.

In the context of this disclosure the term graphene is intended to encompass both pristine graphene (i.e. un-functionalised or substantially un-functionalised graphene) and reduced graphene oxide. When graphene oxide is reduced a graphene like substance is obtained which retains some of the oxygen functionality of the graphene oxide. It may be however that the term ‘graphene’ is excludes both graphene oxide and reduced graphene oxide and thus is limited to pristine graphene. All graphene contains some oxygen, dependent on the oxygen content of the graphite from which is it derived. It may be that the term ‘graphene’ encompasses graphene that comprises up to 10% oxygen by weight, e.g. less than 8% oxygen by weight or less than 5% oxygen by weight.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### Example 1—Cross-Linked GO Laminate Membranes

Graphite oxide was prepared from natural graphite through modified Hummer's method using sulphuric acid and potassium permanganate. The graphite oxide was then dispersed in water by ultrasonication to obtain the stable aqueous graphene oxide (GO) dispersion. The unexfoliated graphite oxide and few layer graphene oxide flakes were removed by centrifugation and the supernatant containing the single layer GO sheets was used for the membrane preparation. Then, a cross linker selected from poly vinyl alcohol (PVA), ethylenediamine (EDA), poly (styrene-4-sulfonate) (PSS), poly Allylamine (PAA) and poly(2-acrylamido-2-methyl-1-propanesulfonic acid) (poly AMPS) (20% with respect to the weight of the GO present in solution) was dissolved in GO suspension and left for overnight stirring at room temperature. By adjusting the volume of each solution, GO-PVA, GO-EDA, GO-PSS, GO-PAA and GO-polyAMPS membranes of thicknesses ˜500 nm, were prepared on the polyethersulfone (PES) membrane (diameter of 47 mm with pore size ˜0.2 μm) using vacuum filtration. The membranes were dried in a vacuum desiccator in prior to use for the pressure filtration experiments.

X-ray diffraction (XRD) was used to measure the inter-layer d spacing (capillary width) of the GO membranes. The d-spacing values are calculated from the peak position in XRD pattern using Bragg's law nλ=2d sin θ. For XRD experiments, GO-PVA, GO-EDA, GO-PSS, GO-PAA and GO-polyAMPS membranes (of thickness ˜5 μm) are prepared by vacuum filtration of each solution through Anodisc alumina membranes with a pore size of 0.02 μm. These membranes were dried under vacuum to peel a free standing GO membrane with different linker molecules for the XRD measurements. Bruker D8-Discover X-ray diffractometer was used to estimate the d-spacing of the fabricated free standing membranes in both dry and wet states. XRD pattern (5<2θ<25) of the each free standing membrane was obtained at room temperature and room humidity and left these membranes in water for 24 hrs. Further, the XRD measurements were conducted on soaked membranes in the same 2θ range to estimate the swelling effect. From the XRD measurements of all the GO membranes with different linker molecules, GO-polyAMPS membrane has shown very small increase in the d-spacing from 8.6 Å (in dry state) to 9.1 Å (in wet state).

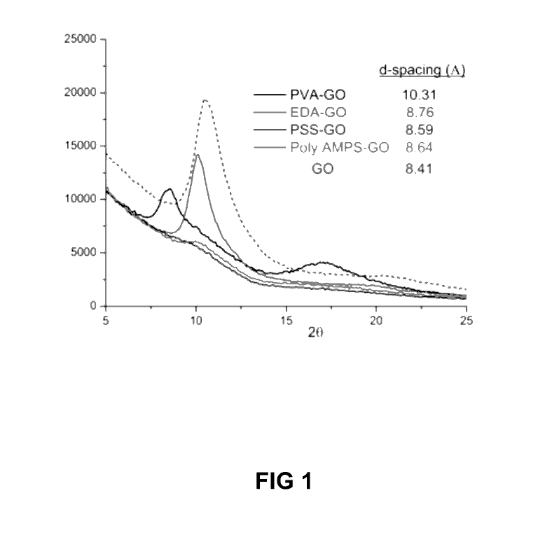

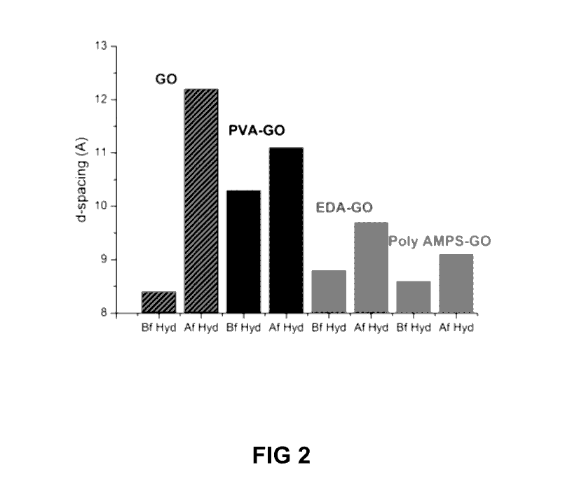

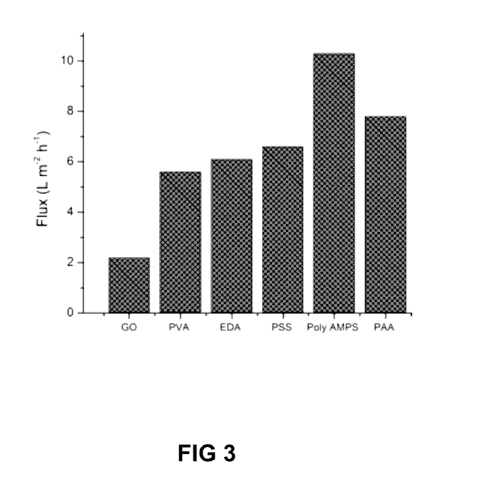

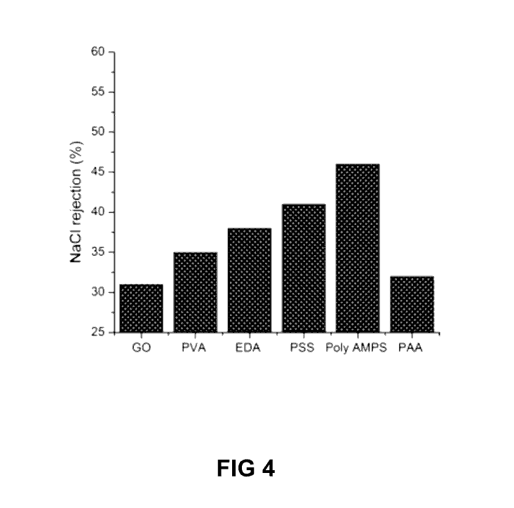

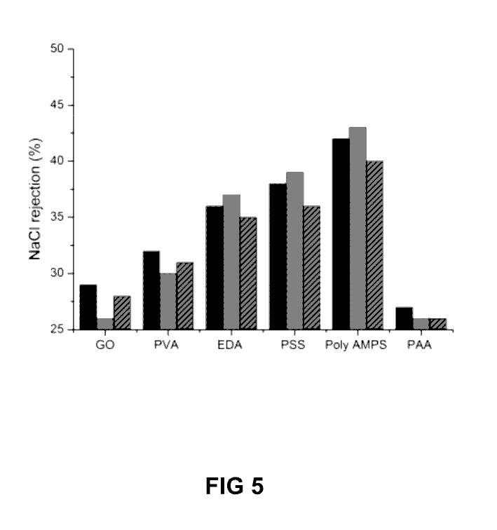

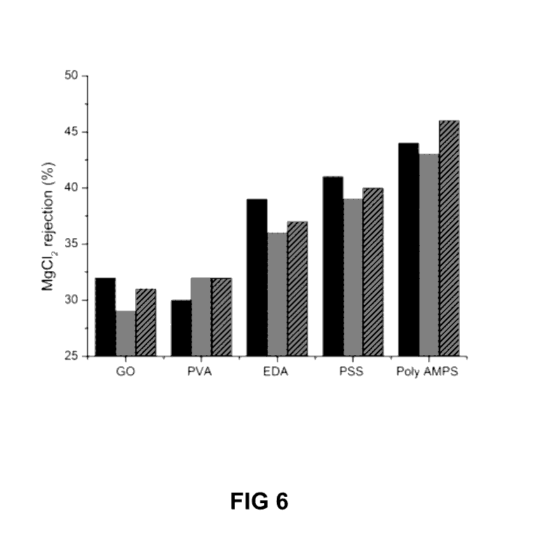

In the present study, we have used Sterlitech HP4750 stirred cell for pressure filtration experiments. Various GO membranes with different linkers prepared on the PES were placed in the pressure filtration cell with a porous metal support and performed the pressure filtration experiments for 2 mg/ml MgCl₂ and NaCl solutions by applying 26 bar pressure using a compressed gas cylinder. The solution permeated through the membranes was collected from the permeate tube fixed to the pressure filtration cell. Among all the GO membranes with different linkers, GO-polyAMPS membrane has shown flux rate of 10 L m⁻² h⁻¹ with a salt rejection ˜50%. The data obtained is shown in FIGS. 1 to 6.

### Example 2—Graphene Oxide/Graphene Composite Laminate Membranes

250 mg of graphite oxide (prepared as in Example 1) and 125 mg of pristine graphite powder were sonicated in 250 ml of DI water for 24 hrs to prepare a Gr-GO dispersion. The Gr-GO suspension was then centrifuged at 2500 rpm to remove the unexfoliated graphite oxide and graphite particles with the supernatant containing the mono and few layers of GO and graphene flakes (this sample was denoted as denoted as Gr-GO-2500). In this method, graphene oxide helps exfoliated graphene to disperse in water to form a stable aqueous suspension.

Gr-GO membranes were prepared by vacuum filtration of Gr-GO dispersion through an Anodisc membrane filter (47 mm in diameter, 0.2 mm pore size) similarly to the method described in Example 1. Gr-GO membranes with Anodisc support were glued onto copper plates which exposes an effective area of ˜1 cm² of the membrane. The copper plate was then placed in a permeation setup containing the feed and permeates compartments. In a typical experiment, feed compartment filled with 1 M aqueous solution of various salts and the permeate compartment was filled with DI water and kept undisturbed for 24 hrs. Inductively coupled plasma optical emission spectroscopy (ICP-OES) was used to find the ion species concentration in the permeate cell. Also these results were cross checked by carefully weighing the left over material after the evaporation of water in permeate compartment. It is found that the permeation rate for Mg⁺² and Na⁺ ions for the Gr-GO membrane is ˜2×10⁻³ and 3×10⁻³ mol/h/m² which is 1000 times smaller when compared to that of the GO laminate membrane which does not comprise graphene or a cross-linking agent. In another permeation experiment with GO-polyAMPS, the permeation rate of Mg⁺² ions found to be ˜1×10⁻² mol/h/m².

The amount of graphene present in the Gr-GO suspension can be controlled by centrifuging the dispersion obtained from sonication of the graphite and graphite oxide mixture at differing speeds. Thus, samples obtained from sonication of the graphite and graphite oxide mixture as described above were centrifuged at 5000, 7500 and 10000 rpm and the resultant suspension was formed into a laminate membrane as described above. From the permeation experiments with Gr-GO membranes made of the Gr-GO dispersion centrifuged at 5000, 7500 and 10000 rpm (denoted as Gr-GO-5000, Gr-GO-7500 and Gr-GO-10000), it was found that permeation rate of the Mg⁺² ions (given in the table below) increased for Gr-GO membranes prepared with the Gr-GO dispersion centrifuged at higher speeds. Permeation rate of Mg⁺² ions in the GO/graphene-10000 is 10 times more than that of in the GO/graphene-2500. It is expected that lower centrifugation rates result in a higher proportion of the membrane containing few layer graphene too.

| | Permeation |
|---|---|
| Membrane | rate (mol/h/m²) |
| Gr-GO-2500 | 2.18 × 10⁻³ |
| Gr-GO-5000 | 1.88 × 10⁻² |
| Gr-GO-7500 | 1.95 × 10⁻² |
| Gr-GO-10000 | 2.47 × 10⁻² |

### Example 3—Graphene Oxide/Graphene Composite Laminate Membranes

Further, four different concentrations of Gr-GO aqueous dispersions were prepared by exfoliating the graphite flakes and graphite oxide in the weight ratio (graphite oxide/graphite) of 1:1, 1:2, 1:5 and 1:9. 0.175 g of graphite oxide was sonicated in 120 ml deionised water along with different weights of graphite flakes varying as 0.175 g, 0.35 g, 0.875 g and 1.575 g for 50 hrs. Supernatant of the resulting dispersion was collected after few hours to avoid the unexfoliated graphite and unstable aggregates which settles down gradually. Subsequently, the supernatant was centrifuged twice for 25 mins at 2500 g to obtain the homogenous Gr-GO aqueous dispersion containing mono and few layers GO and graphene flakes. The Gr-GO membranes were prepared by vacuum filtration of Gr-GO dispersion through an Anodisc membrane filter (47 mm diameter, 0.02 μm pore size) and dried in a vacuum desiccator.

For the permeation experiments, Gr-GO membranes with Anodisc support were glued onto copper plates in such a way that an effective area of ˜1 cm² of the membrane is exposed [15]. A typical permeation experiment was carried out for 24 hrs by fixing the membrane attached copper plate in a permeation setup where feed compartment filled with 1 M aqueous solution of various salts (KCl, NaCl, LiCl and MgCl₂) and the permeate compartment was filled with deionised water. Inductively coupled plasma optical emission spectroscopy (ICP-OES) was used to find the ion species concentration in the permeate cell and these results were cross checked by carefully weighing the left over material after the evaporation of water in permeate compartment.

FIG. 8a shows the optical photograph of 100 μg/ml concentrated GO and Gr-GO aqueous colloidal suspensions with increasing wt % of graphene (from left to right). The pale brown coloured GO suspension gradually turns into dark with increasing initial amount of graphite starting material which suggests the increased amount of exfoliated graphene in Gr-GO dispersions in the case of higher initial graphite content. Weight of graphite oxide is kept constant and varied the initial weight of graphite flakes for preparation of each solution in order to estimate the actual wt % of graphene exfoliated into GO suspension. FIG. 8b shows the concentration and actual wt % of exfoliated graphene in GO and Gr-GO dispersions as a function of initial graphite oxide/graphite weight ratio. Three membranes (GO and Gr-GO) prepared from the known amount of volume of each dispersion were carefully weighed using “μg” precision microbalance to determine the concentration of GO and Gr-GO dispersions. Subsequently, actual wt % of exfoliated graphite in the different Gr-GO dispersion is estimated from the concentration values and found that ˜5.5 wt %, 4.2 wt %, 2.2 wt % and 1.3 wt % of exfoliated graphene (with respect to the weight of GO) is present in the membranes made from the Gr-GO dispersions of 1:9, 1:5, 1:2 and 1:1 initial graphite oxide/graphite ratio, respectively.

X-ray diffraction technique has been used to analyse the changes in the interlayer spacing of GO and Gr-GO membranes in both dry and wet states. In the dry state, both pristine GO and Gr-GO membranes show similar (001) diffraction peak at ≈10.5±0.5° indicating similar laminar structures for both the membranes. To determine the swelling behaviour, GO and Gr-GO membranes were soaked for a day in deionised water. As expected, the interlayer spacing (˜8.4 Å in dry state) of GO membrane increased to 14 Å after soaking. In contrast to the GO membranes, Gr-GO membranes having a higher wt % of exfoliated graphene flakes have shown less swelling. For example, the interlayer spacing of Gr-GO membranes with 5.5 wt % and 2.2 wt % of exfoliated graphene is respectively ≈10.3 Å and 11.4 Å in the wet state. This indicates that incorporation of exfoliated graphene in the GO membrane controls the swelling of GO membrane by controlling the amount of water in the interlayer space. Without wishing to be bound by theory, this could be due to the more hydrophobic nature of exfoliated graphene which lowers the amount of water in the interlayer spaces of the membrane.

Homogeneity of the Gr-GO membranes was further confirmed by the SEM investigations. FIGS. 7a and 7b show the cross-sectional and in-plain SEM image of Gr-GO membrane respectively. Distribution of exfoliated graphite (flaky features in FIG. 7b) in the membrane is found to be very uniform and they are shown to be assembled in a layered structure. FIG. 7c shows the schematic structure of layered structure of Gr-GO membrane.

FIG. 8d summarizes the permeation rate for different ions (K⁺, Na⁺, Li⁺ and Mg⁺²) through the GO and Gr-GO membranes made from 1:2 and 1:9 dispersions. From FIG. 8d, it is apparent that the value of permeation rate observed for Mg⁺² ions through Gr-GO membrane made of 1:9 dispersion is ˜1000 times smaller than the permeation rate through pristine GO membrane. This can be explained by the lesser swelling effect in 1:9 Gr-GO membrane with respect to the pristine GO membrane. Interlayer distance of 1:9 Gr-GO membrane increases to 10 Å, whereas it is 14 Å for the pristine GO membrane after soaking in water. Similarly, significant decrease (˜100 to 1000 times) in the permeation rate for K⁺, Na⁺ and Li⁺ ions is observed in the case of 1:9 Gr-GO membranes. The water permeation rate through GO and Gr-GO membrane has also been measured by monitoring the osmotic height difference and it was found that addition of graphene to GO membrane did not change the osmotic height difference, indicating similar water permeation rate for both GO and Gr-GO membranes.

NaCl salt rejection properties of 1:9 Gr-GO membranes were further measured using forward osmosis technique by keeping concentrated sugar solution as a draw solute. Salt rejection was calculated using the equation 1-Cₚ/C_{f} where Cₚ is the concentration of NaCl in transmitted water and C_{f} is the concentration of NaCl in feed side. This analysis yields 96% salt rejection for the 1:9 Gr-GO membranes. The salt rejection of GO only membranes is around 70%.

1. A graphene oxide laminate membrane comprising graphene oxide (GO) flakes and graphene flakes.

2. A membrane of claim 1, wherein the graphene flakes are from 0.5 wt % to 10 wt % of the flakes of which the graphene oxide laminate membrane is comprised.

3. A membrane of claim 1, wherein the graphene flakes are pristine graphene.

4. A membrane of claim 1, wherein the graphene oxide laminate is supported on a porous material.

5. A membrane of claim 1 having a thickness greater than about 100 nm and wherein the graphene oxide flakes of which the membrane is comprised have an average oxygen:carbon weight ratio in the range of from 0.2:1.0 to 0.5:1.0 and wherein the membrane.

6. A membrane of claim 1, wherein the graphene oxide flakes of which the laminate is comprised have an average oxygen:carbon weight ratio in the range of from 0.3:1.0 to 0.4:1.0.

7. A membrane of claim 1, wherein the graphene oxide laminate membrane has a thickness between 1 μm and 15 μm.

8. A membrane of claim 1, wherein the graphene oxide laminate further comprises at least one cross-linking agent.

9. A method of reducing the amount of one or more solutes in an aqueous mixture to produce a liquid depleted in said solutes, the method comprising:
a) contacting a first face of a graphene oxide laminate membrane with the aqueous mixture comprising the one or more solutes;
b) recovering the liquid from or downstream from a second face of the graphene oxide laminate membrane;
wherein the graphene oxide laminate membrane comprises GO flakes and graphene flakes.

10. A method of claim 9, wherein the graphene flakes are from 0.5 wt % to 10 wt % of the flakes of which the graphene oxide laminate membrane is comprised.

11. A method of claim 9, wherein the graphene flakes are pristine graphene.

12. A method of claim 9, wherein the graphene oxide laminate membrane has a thickness greater than about 100 nm and wherein the graphene oxide flakes of which the membrane is comprised have an average oxygen:carbon weight ratio in the range of from 0.2:1.0 to 0.5:1.0 and wherein the membrane.

13. A method of claim 9, wherein the graphene oxide laminate membrane further comprises at least one cross-linking agent.

14. A method of reducing the amount of one or more solutes in an aqueous mixture to produce a liquid depleted in said solutes, the method comprising:
a) contacting a first face of a graphene oxide laminate membrane with the aqueous mixture comprising the one or more solutes;
b) recovering the liquid from or downstream from a second face of the graphene oxide laminate membrane;
wherein the graphene oxide laminate membrane has a thickness greater than about 100 nm and wherein the graphene oxide flakes of which the membrane is comprised have an average oxygen:carbon weight ratio in the range of from 0.2:1.0 to 0.5:1.0 and wherein the membrane comprises GO flakes and at least one cross-linking agent.

15. A method of claim 14, wherein the cross-linking agent is a polymer.

16. A method of claim 15, wherein the cross-linking agent is a charged polymer.

17. A method of claim 14, wherein the d-spacing of the hydrated graphene oxide laminate membrane is below 12 Å.

18. A method of claim 17, wherein the d-spacing of the hydrated graphene oxide laminate membrane is below 10 Å.

19. A method of claim 9, wherein the method is a process of selectively reducing the amount of a first set of one or more solutes in an aqueous mixture without significantly reducing the amount of a second set of one or more solutes in the aqueous mixture to produce a liquid depleted in said first set of solutes but not depleted in said second set of solutes.

20. A method of claim 9, wherein the method is continuous.

21. A method of claim 9, wherein pressure is applied to push the aqueous mixture through the graphene oxide membrane.

22. A method of claim 9, wherein the graphene oxide membrane is supported on a porous material.

23. A method of claim 9, wherein the graphene oxide flakes of which the laminate is comprised have an average oxygen:carbon weight ratio in the range of from 0.3:1.0 to 0.4:1.0.

24. A method of claim 9, wherein the graphene oxide laminate membrane has a thickness between 1 μm and 15 μm.

25. A method of claim 9, wherein the solutes the amounts of which are reduced in the aqueous mixture include NaCl.

26. A method of reducing the amount of one or more predetermined solutes having a hydration radius in the range of from about 3.5 Å to about 4.5 Å in an aqueous mixture to produce a liquid depleted in the predetermined solutes, the method comprising;
a) determining the identity of one or more solutes in the aqueous mixture which are to be selected for exclusion by the membrane;
b) correlating the required d-spacing in the graphene oxide membrane with the hydration radius of the or each predetermined solute;
c) forming a graphene oxide laminate membrane comprising GO flakes and also comprising monolayer or few layer graphene flakes and/or at least one cross linking agent and having a reduced d-spacing relative to a membrane which does not comprise the cross-linking agent;
d) contacting a first face of a graphene oxide laminate membrane with the aqueous mixture comprising one or more solutes; and
e) recovering the liquid from or downstream from a second face of the membrane.

27. A method of tuning the d-spacing of a cross-linked graphene oxide laminate size exclusion filtration membrane, the method comprising:
a) selecting at least one cross-linking agent and/or monolayer or few layer graphene flakes which provides a membrane having a desired capillary size when the membrane is hydrated; and
b) forming a graphene oxide laminate membrane comprising GO flakes and also comprising monolayer or few layer graphene flakes and/or the at least one cross linking agent.

28. A method of limiting the d-spacing of a hydrated graphene oxide laminate size exclusion filtration membrane to below 12 Å, the method comprising:
forming a graphene oxide laminate membrane comprising GO flakes and also comprising monolayer or few layer graphene flakes and/or at least one cross linking agent.

29. A use of monolayer or few layer graphene flakes and/or at least one cross linking agent to limit the d-spacing of a hydrated graphene oxide laminate size exclusion filtration membrane to below 12 Å.

30. A graphene oxide laminate membrane comprising GO flakes and a charged polymer as a cross-linking agent.

31. A graphene oxide laminate membrane comprising GO flakes and at least one cross-linking agent and having, when hydrated, a reduced pore size relative to a hydrated graphene oxide membrane which does not comprise the cross-linking agent, and wherein the pore size in the hydrated membrane is operative to substantially exclude at least the passage of solutes having a hydration radius in the range of from about 3.5 Å to about 4.5 Å when present in an aqueous mixture.

32. A filtration device comprising a graphene oxide laminate membrane of claim 1.

33. A method of producing a graphene oxide laminate membrane comprising GO flakes and graphene flakes, the method comprising:
a) providing a suspension of graphite flakes and graphite oxide flakes in an aqueous medium;
b) subjecting the graphite flakes and graphite oxide flakes in the aqueous medium to energy to obtain an aqueous suspension comprising graphene flakes and graphene oxide flakes;
c) optionally removing any graphite or undesired few-layered graphene flakes from the suspension; and
d) filtering the suspension through a porous material to provide a graphene oxide laminate membrane comprising GO flakes and graphene flakes, the laminate membrane being supported on the porous material.

34. A method of claim 14, wherein the method is a process of selectively reducing the amount of a first set of one or more solutes in an aqueous mixture without significantly reducing the amount of a second set of one or more solutes in the aqueous mixture to produce a liquid depleted in said first set of solutes but not depleted in said second set of solutes.

35. A method of claim 14, wherein the method is continuous.

36. A method of claim 14, wherein pressure is applied to push the aqueous mixture through the graphene oxide membrane.

37. A method of claim 14, wherein the graphene oxide membrane is supported on a porous material.

38. A method of claim 14, wherein the graphene oxide flakes of which the laminate is comprised have an average oxygen:carbon weight ratio in the range of from 0.3:1.0 to 0.4:1.0.

39. A method of claim 14, wherein the graphene oxide laminate membrane has a thickness between 1 μm and 15 μm.

40. A method of claim 14, wherein the solutes the amounts of which are reduced in the aqueous mixture include NaCl.

41. A filtration device comprising a graphene oxide laminate membrane of claim 30.

42. A filtration device comprising a graphene oxide laminate membrane of claim 31.
